(19) United States
(12) Patent Application Publication
(10) Pub. No.: US 2024/0209887 A1
(43) Pub. Date: Jun. 27, 2024

(54) SPECIALIZED FASTENERS AND HOLIDAY LIGHT CLIPS FOR GUTTERS AND GUTTER GUARDS

(71) Applicant: Gutterglove, Inc., Franklin, TN (US)

(72) Inventors: Cullen B. Rodgers, Thompson's Station, TN (US); Jacob Alan Kobliska, Farmington, AR (US)

(21) Appl. No.: 18/146,249

(22) Filed: Dec. 23, 2022

(51) Int. Cl. F16B 25/00; F16B 2/22; F16B 25/10; F21V 21/08

(52) U.S. Cl. CPC F16B 25/0021; F16B 2/22; F16B 25/103; F21V 21/08

(57) ABSTRACT

A single piece gutter/gutter-guard screw has a head with a shoulder integrally formed thereto and a threaded screwing body integrally formed to the shoulder. A diameter of the threaded screwing body is smaller than the largest diameter of the shoulder's bottom, and a largest diameter of a top of the shoulder is smaller than a largest diameter of the head's bottom. The screw provides a gap that is a height of the shoulder when the screw is screwed into a substrate. An attached clip (in the gap) provides support for an attached wire or object and composed of a generally L-shaped body with a top member joined to a side member. A front slit in the clip provides entrance to at least an attachment structure within the top member, configured to fit onto the screw. An attachment mechanism is in the side member.

### FIELD

This invention relates to a gutter guard/gutter fastener and associated clip. More particularly, this invention is directed to a gutter guard/gutter fastener designed to provide fitment for a specially designed clip for hanging lights, ornaments and the like.

### BACKGROUND

Hanging lights or other ornaments, wiring, etc. along a roof's edge involves attaching some means for “holding” the light/wiring. Typically, homeowners strike nails or attach hooks into the roof's fascia to support the wires (ultimately damaging the fascia) or try to weave them though the shingles or around the gutters. All of these approaches are ad hoc, and often done so poorly to result in permanent damage to the fascia, or mis-hanging ornaments. Further, the non-trivial effort to accomplish this requires homeowners to work on ladders which results in many fall-related injuries each year.

Therefore, there has been a long-standing need for better system(s) and method(s) to facilitate the hanging and mounting of holiday lights and the sort to a roof. Using a special fastener(s) and specially designed clip(s), various approaches that overcome the prior art's difficulties are described below.

### SUMMARY

The following presents a simplified summary in order to provide a basic understanding of some aspects of the claimed subject matter. This summary is not an extensive overview and is not intended to identify key/critical elements or to delineate the scope of the claimed subject matter. Its purpose is to present some concepts in a simplified form as a prelude to the more detailed description that is presented later.

In one aspect of the disclosed embodiments, a clip-attachable screw configured for screwing into a gutter or gutter guard is provided, comprising: a head; a shoulder immediately below and integrally formed to a bottom of the head; and a threaded screwing body immediately below and integrally formed to a bottom of the shoulder; wherein a diameter of the threaded screwing body is smaller than a largest diameter of the bottom of the shoulder, and a largest diameter of a top of the shoulder is smaller than a largest diameter of the bottom of the head, wherein the screw is configured to provide a gap that is a height of the shoulder when the screw is screwed into a substrate, for attachment by a clip.

In another aspect of the disclosed embodiments, the above screw is provided, wherein an entirety of the threaded screwing body threaded; and/or wherein a tip of the threaded screwing bottom is formed as a drill end; and/or wherein the bottom of the head is defined by a washer integrally formed to the head; and/or wherein the washer is larger in diameter than a diameter of the head; and/or wherein the bottom of the shoulder is defined by a washer integrally formed to the bottom of the shoulder; and/or wherein a diameter of the washer is approximate to a diameter of the head; and/or sides of the head are octagonally arranged for fitment of a wrench; and/or wherein a top of the head is channeled for fitment of a screwdriver. ; and/or wherein the screw is between 0.7-0.9 inches in length; and/or wherein a height of the shoulder is between 0.05-0.1 inches; and/or the screw is formed from metal.

In yet another aspect of the disclosed embodiments, a clip configured to attach to a gutter guard screw, and configured to provide support for a wire is provided, comprising: a body having a top member and a side member joined to the top member, wherein the body has a generally L-shaped cross-section, wherein the top member has a distal portion with opposing legs, a separation between the opposing legs forming an attachment structure; and an attachment mechanism disposed on the side member, wherein when the clip is in use, the attachment structure is configured to receive the gutter guard screw and the attachment mechanism the wire.

In yet another aspect of the disclosed embodiments, the above clip is provided, wherein the side member is joined to the top member between 45-135 degrees; and/or wherein the attachment structure further comprises a first and second hole, each hole in line with each other and having a passage way therebetween; and/or further comprising, a cut at an end of the second hole to provide stress relief to the clip; and/or wherein the top member is shaped to be slightly non-planar; and/or the attachment structure is an open ended slit; and/or wherein the slit has holes and the holes operate as the attachment mechanism; and/or wherein the side member is multi-walled to form a well for fitment of the wire; and/or wherein the clip is formed from polypropylene plastic; and/or wherein the top member is approximately 0.5-0.9 inches in length and the side member is approximately 0.5-0.3 inches in length; and/or the attachment structure is at least one of shaped as a loop with an upper opening, a main loop with a smaller diameter arc at a top of the main loop, and an opening surrounded with flexing tabs.

In yet another aspect of the disclosed embodiments, an integral, one piece clip configured to attach to a prospective clip-attachable, gutter or gutter guard screw, and configured to provide support for a prospective wire or object attached to the clip is provided, comprising: a single strand having a first and second hooking ends.

In yet another aspect of the disclosed embodiments, the above clip is provided, wherein the hooking ends are at least one shaped as a loop with an upper opening, a main loop with a smaller diameter arc at a top of the main loop, and an opening surrounded with flexing tabs.

In yet another aspect of the disclosed embodiments, a method of attaching a light or object to a roof edge is provided, comprising: screwing a clip-attachable, gutter or gutter guard screw into a gutter or gutter guard resting on the gutter, the screw comprising: a head; a shoulder immediately below and integrally formed to a bottom of the head; and a threaded screwing body immediately below and integrally formed to a bottom of the shoulder; attaching a clip to the screw's shoulder; and placing the light or object to the clip to be secured by the clip.

In yet another aspect of the disclosed embodiments, the above method is provided, wherein the clip is a loop and ends of the loop are attached to the screw's shoulder with the light or object placed within the loop; and/or the above clip is provided, wherein the hooking ends are at least one shaped as a loop with an upper opening, a main loop with a smaller diameter arc at a top of the main loop, and an opening surrounded with flexing tabs; and/or screwing a clip-attachable, gutter or gutter guard screw into a gutter or gutter guard resting on the gutter is provided, the screw comprising: a head; a shoulder immediately below and integrally formed to a bottom of the head; and a threaded screwing body immediately below and integrally formed to a bottom of the shoulder; attaching a clip to the screw's shoulder; and placing the light or object to the clip to be secured by the clip; and/or wherein the clip is a loop and ends of the loop are attached to the screw's shoulder with the light or object placed within the loop.

### BRIEF DESCRIPTION OF THE DRAWINGS

FIG. 1 is a side view of an exemplary fastening member.

FIG. 2 is a cut-away illustration of the embodiment of FIG. 1, with the exemplary fastening member is inserted into a substrate.

FIG. 3 is a sectional, cut-away illustration of the embodiment of FIG. 1 installed on a gutter guard.

FIG. 4A contains top views of an open mouthed exemplary clip and as attached to an exemplary fastening member.

FIG. 4B contains top views of an arced-ringed exemplary clip and attached to an exemplary fastening member.

FIG. 4C contains top views of a push-on-type exemplary clip and attached to an exemplary fastening member.

FIG. 5A is a bottom perspective view of another exemplary fastening member.

FIG. 5B is a perspective head-side view of an exemplary fastening member.

FIG. 5C is a side view of an exemplary fastening member.

FIG. 5D is a top side of an exemplary fastening member.

FIG. 6A shows a front perspective view of another exemplary clip.

FIG. 6B is shows a bottom perspective view of an exemplary clip.

FIG. 6C shows a front view of an exemplary clip.

FIG. 6D shows a top view of an exemplary clip.

FIG. 6E shows a side profile view of an exemplary clip.

FIG. 7A is a view of an attached exemplary fastening member.

FIG. 7B is a closeup view showing an exemplary clip ready to be inserted into the attached exemplary fastening member.

FIG. 7C is a closeup view showing an exemplary clip inserted into a first position in the attached exemplary fastening member.

FIG. 7D is a closeup view showing an exemplary clip inserted into a second position in the attached exemplary fastening member.

FIGS. 8A-B illustrate another embodiment type for a “clipping” mechanism.

FIGS. 9A-B are examples of variations of the embodiment type shown in FIG. 8A.

### DETAILED DESCRIPTION

The present description is directed to various embodiments of a specialized gutter guard/gutter fastener and specialized “hanging” clip(s). The clip(s) are designed to removably “fit” into or onto the top section of the fastener and at its other end, have a means for hanging/securing the desired holiday lights, wires, ornaments, etc., thereto. The exemplary fastener(s), being of a modified screw form, can easily be screwed into a gutter or to function to attach the gutter guard to the gutter (to accomplish that task, if need be), and still allow the specialized clip to be affixed to it in an easy way. The disclosed designs remove the need to attach anything to the roof's fascia or supporting structure and the exemplary clips provide a very convenient hook-like (or equivalent) structure for the homeowner to hang his lights or ornaments. Because the clips can be attached and removed with ease, when the holiday season is over, very little effort is needed to unhang the lights, wires, etc.

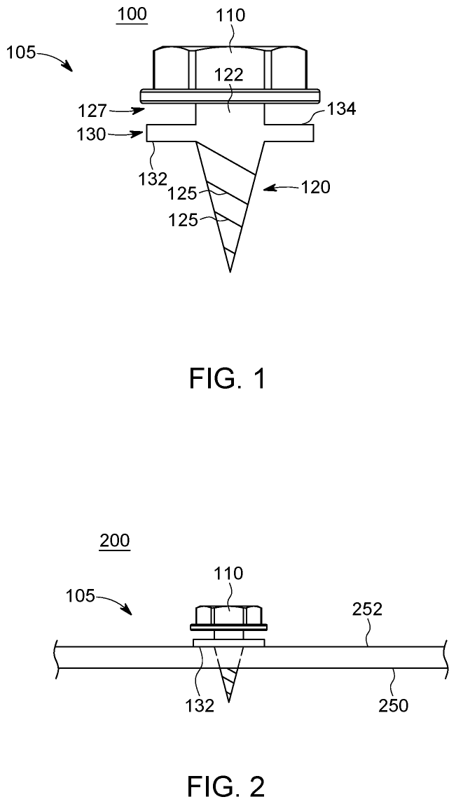

FIG. 1 is a side view 100 of an exemplary fastening member 105 that has a head 110, an integral penetrating body 120 extending substantially perpendicular from the head 110 with an intermediate flange or collar 130 colinear to and integrally formed with the penetrating body 120 at a predetermined distance
providing a gap 127 between the bottom of the head 110 and top 134 of the collar 130. Neck section 122 of the penetrating body 120 is disposed between the head 110 and the collar 130, wherein a hook or loop or clip of some sort, when fitted into the gap 127, can hang “on” the neck section 122.

The penetrating body 120 can be threaded 125 and serves as a screwable shaft to allow the fastening member 105 to sufficiently penetrate into a substrate, such as a gutter part and/or gutter guard part (not shown), whereas threads 125 on the penetrating body 120 draw the fastening member 105 into the underlying substrate. When situated into a gutter guard part and/or gutter part, the collar's 130 bottom surface 132 prevents further penetration of penetrating body 120, thereby proxying as a depth stop.

In a prototype embodiment, the fastening member 105 shown in FIG. 1 is similar to a #8, hex headed, sheet metal flange screw but with an integral washer-like standoff that is displaced from the screw's head to allow placement of a clip or other device. Typical flange screws have a washer but it is affixed directly to the head and there is no gap therein.

The makeup and composition of the fastening member 105 is presumed here to be of metal, but it is possible to utilize a different material, such as plastic, nylon and so forth, including combinations of such. The length of the penetrating body 120 can vary depending on the application and can be long enough to fully penetrate the mounted-to substrate, extending through the substrate, or may be long enough to sufficiently penetrate the mounted-to substrate without extending through the substrate. As stated above, the length is application dependent.

On the reverse side of the collar 130, the top surface 134 is separated from the head 110 by approximately 0.05-0.1 inches, to provide a fixed gap 127 whereas a clip (not shown) can be inserted or affixed therein. This gap 127 may or may not have threads, depending on the design. Also, this gap distance is representative of a commercial embodiment and may be increased or altered according to design preference. Further, the thickness of the neck section 122 within the gap 127 may be constant or vary (can be asymmetrical). In the embodiments shown, the diameter of the neck section 122 is shown as being smaller than the diameter of the head 110. The head 110 can be faceted 112 and/or and may be grooved (not shown) to permit use of a socket or wrench to tighten or loosen the fastening member 105, or a screwdriver or the like (Phillips, Allen, Star, Torx, etc.). The head 110 shapes shown are believed to be best modes and therefore may vary and are not limited to the embodiments shown here.

In a prototype embodiment, the length of the exemplary fastening member 105 was approximately ⅝”-¾”, to allow for sufficient length to penetrate through the bulk of a typical gutter lip's metal/material while not penetrating into a bottom side of the gutter (see FIG. 2, for example). Of course, longer lengths or shorter lengths may be used, depending on design preference and gutter material thickness and any gutter guard overlay.

The diameter of the collar 130 is illustrated as approximately the same diameter of the head 110, however, different diameters may be utilized, either larger or smaller. Also, the thickness, flexibility, shape and even the angle of the collar 130 may differ from what is shown. For example, collar 130 may be triangular in form (versus circular), oblong, or square, star-shaped, propeller-shaped, etc. Moreover, in some embodiments the collar 130 may not be symmetrical about the penetrating body 120, being off-centered, if so desired. The angle of the collar 130 is shown as parallel to the head 110, but it is possible the collar 130 may be cone-shaped or tilted, or of a non-uniform thickness. Further, the collar 130 may composed of a thin enough or flexible material to bend upwards when being threaded into a substrate, narrowing gap 127 to pinch a clip inserted within gap 127, if so desired. Further, one or more different types or combinations of threads 125 may be used. As a non-limiting example, one thread type may facilitate easier penetration while another thread type facilitate better tightening. The end of the penetrating body 120 may also be of a different shape—rounded, slotted/slitted, etc. In some embodiments, the size, pitch, etc. of the threads may be different than shown, noting such changes are within the scope of one of ordinary skill and this disclosure.

FIG. 2 is a cut-away illustration of the embodiment of FIG. 1, but the fastening member 105 is inserted into a substrate 250. Here, the substrate 250 can be part of a gutter or gutter guard. Typically, the thickness of such a gutter or gutter guard material made, for example, from aluminum, constituting the substrate 250 is 0.016-0.08 inches. Other thicknesses are possible being dependent on the material and design objective. Evident is the contact or near abutment of bottom surface 132 of collar 130 to the top 252 surface of substrate 250. With sufficient tightening, the resultant friction between the two surfaces (132, 252) provides securement (in addition to the threads—seen in FIG. 1) of the fastening member 105 to the substrate 250.

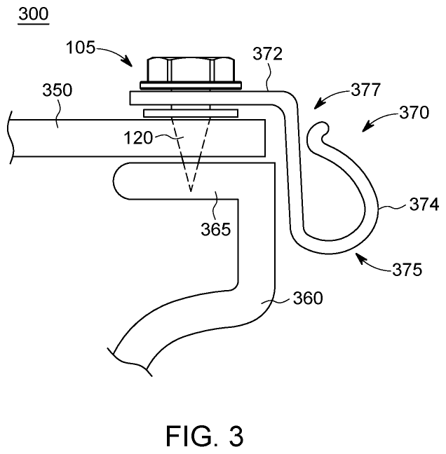

FIG. 3 is a sectional, cut-away illustration 300 of the embodiment of FIG. 1 installed on a gutter guard 350 sitting on gutter's lip 365 with an attached clip 370. Fastening member 105's penetrating body 120 is shown here penetrating entirely through gutter guard 350 and also into gutter 360's gutter lip 365. Top part 372 of clip 370 is mounted within the fastening member's 105 gap (obscured from view). Clip 370 is shown here with a bottom part 375 having the general shape of a “hook” 374 with a narrowed opening 377 to accommodate the entrance and retainment of holiday lights, wires, decorations and the sort. Since shapes to assist in “hanging” items are well known in the industry, other hook shapes or otherwise with different openings, shapes, thicknesses, dimensions, etc. can be used, if so desired. The top part 372 is long enough to extend past the end of the gutter 360 to allow the bottom part 375 to drop down the gutter's side. The clip's overall shape can be that of an inverted “L” with the bottom part 375 having a “hook” or “U” or equivalent form to permit fitting and lodging of a holiday light, wire, etc.

Bottom part 375 is integral to the top part 372 and is shown here as angled or perpendicular to the plane of the top part 372 so that it is proximal to the edge surface of the gutter guard 350 and side of gutter 360. However, the angle be altered, being less or greater than 90 degrees, if so desired, and even negative (above the plane of top part 372). However, having the bottom part 375 below the top part 372 helps to “hang” the clip 370 onto the fastening member 105, since the bottom part 375 will be bearing the weight of the attached lights, wires, etc. For practical purposes the angle could range between 45-134 degrees. While a hook-like shape 374 is shown, other end shapes may be used.

The clip 370 can be of a uniform thickness, as shown in this illustration, but other or varying thicknesses, shapes and so forth can be devised and implemented without departing from the spirit and scope of this disclosure. For purposes of manufacturing and cost-effectiveness, it is simpler to make a clip 370 from a uniform sheet of material. The clip 370 can be formed of plastic, nylon, metal, rubber, etc., and combinations thereof. In a commercial embodiment, polypropylene plastic (PP) was chosen for the clip material as its strength was found to perform well.

For purposes of simplicity, the FIGS. show a circular top part 372. However, it does not necessarily have to be round or circular in form. A square, triangle, oval, or any other shape can be used, including being non-planar (e.g., hemisphere-like, etc.)

So as to fit within the head-to-collar gap 127 (see FIG. 1), top part 372 is shown to be substantially planar, though it is not absolutely necessary to do so. That is, top part 372 can be wavy, curved, stair-stepped, ridged, etc., and achieve similar results. Alternatively, to help “bind” the top part 372 within the gap 127 (see FIG. 1), it can be of a thickness that is approximate to the thickness of the gap 127, to provide some friction to assist in securing the clip 370. Ideally, but not necessarily, the thickness would be barely larger than the gap 127 and the clip material would compress under the force of being inserted into gap 127, providing additional frictional and securing forces. If a non-planar approach is used, then the varying shape(s) of the top part 372 can act to function equivalently.

For a typical gutter/gutter guard installation, the length of the top part 372 can range from 0.5-0.9 inches and the bottom part 375 (or approximate height of the clip 370) can range from 0.5-3 inches. It is understood these lengths are not to be construed as limiting, but offered only to show the general sizes that would be appropriate for commercial use.

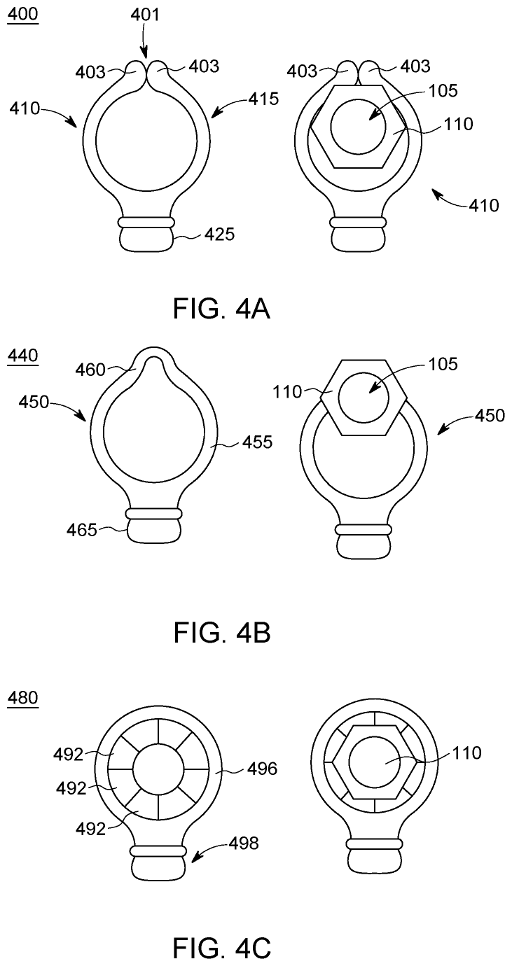

FIG. 4A contains top views 400 of an open mouthed exemplary clip 410 and as attached to an exemplary fastening member 105. This embodiment shows a clip design where the clip 410 is “inserted” into or pushed onto fastening member 105. Representing a “snap around” design where the clip 410 can be spring-biased to open with pressure applied to the mouth under the head of the fastening member, then close once it clears the mouth of fastening member. The left side illustration shows an annular ring 405 with an opening 401 at top portion 415, having edge contours 403 that are relatively smooth and bulbous. Bottom portion 425 represents a top view of the “hook” seen in FIG. 3. As seen in the right side illustration, this opening 401 allows passage of the clip's ring 405 into the gap (not shown) and is secured therein. The diameter of the ring 405 is exaggerated in this view to allow for proper explanation, but the diameter will be sized small enough so that some portion of the head 110 of the fastening member 105 will cover a portion of the ring 405 when the clip 410 is inserted. Otherwise, the clip 410 will simply fall off the head 110. Further, as stated above, the clip 410's top part shown here as annular ring 405 does not necessarily have to be round or circular in form. A square, triangle, oval, or any other shape can be used, including being non-planar (e.g., hemisphere-like, etc.)

FIG. 4B shows top views 440 of an arced-ringed exemplary clip 450 by itself and attached to an exemplary fastening member. The left side illustration shows an annular ring 455 with its top portion extended to form a smaller diameter arc 460. The diameter of the ring 455 will be larger than the fastening member 105 to allow it to slip “over” the head 110, while the diameter of the arc 460 will be smaller than the diameter of the head 110. As seen in the right side illustration, the ring 455 can be slid down so arc 460 can fit between the head 110 and the collar (not shown). To remove the clip 450, the user only needs to push “up” to position the entire ring 455 off the head 110. Bottom portion 465 of the clip 450 will have the appropriate hooking shape. The size is of the clip 450 and opening therein is exaggerated for illustrative purposes.

Further, as stated above, the clip 450's top part shown here as annular ring 455 with contiguous arc 460 does not necessarily have to be bounded or composed of round or circular forms. Circles, squares, triangles, ovals, or any other shape (including combinations) can be used, including being non-planar (e.g., hemisphere-like, etc.) In view of the previous explanations, FIG. 4B's design is understood to be self-explanatory.

FIG. 4C show top views 480 of push-type exemplary clip 490 by itself and attached to an exemplary fastening member. Here, a push-on-type design is contemplated, using an annulus of radially scored sections 492, or tabs connected to an outer rib 496, which flex upward/downward when positioned on to/off of head 110. By their upward/downward movement, scored sections/tabs 492 vary the diameter of open area 494 to allow the clip 490 to slip through the head 110, and secure itself to the gap (not seen) below the head. Variations of the purpose of this push-type design are seen in the industry, such as “teeth or spokes,” or a slit and so forth.

Further, as stated above, the clip 490's top part does not necessarily have to be bounded or composed of round or circular forms. Circles, squares, triangles, ovals, or any other shape (including combinations) can be used, including being non-planar (e.g., hemisphere-like, etc.). Accordingly, modifications and changes to the type and method of using a push-type clip 490 are understood to be within the scope of this disclosure.

In various experiments, it was discovered that a push-type clip (having one of or a variation of the form described above) was superior in that it better enabled the clip to fit closely to the front edge of the gutter, offering more support to the clip. Also, a push-type clip is easier for an installer who might be on a ladder, or in the future a homeowner may be able to install the push-type clips himself by use of an attachment to an extension pole, without requiring a ladder.

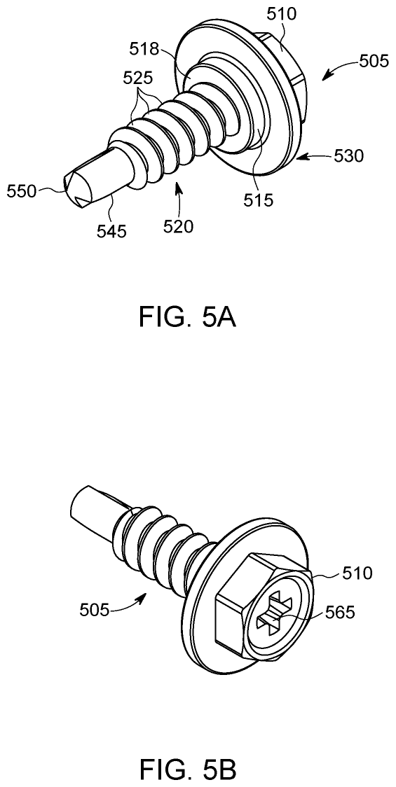

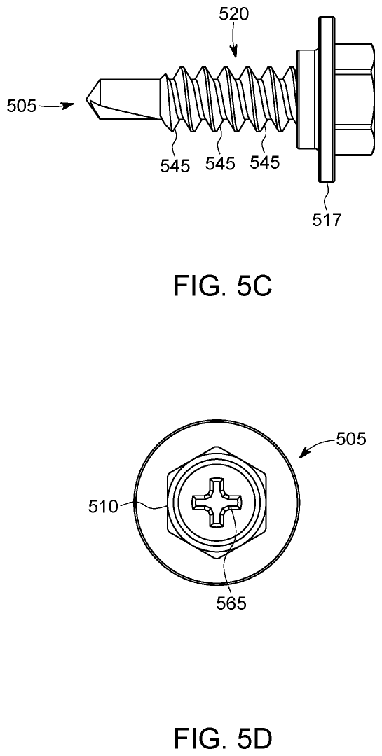

FIGS. 5A-D are various views of another exemplary fastening member 505. FIG. 5A shows is a bottom perspective view of the exemplary fastening member 505. In this embodiment, a modified flange screw approach is used, where a washer 530 is integrally attached to the head 510. The desired clip-connection “gap” is achieved by placing a shoulder 515 between the penetrating body 520 and the washer 530. This shoulder 515 is smaller in diameter than the washer 530 but larger than in diameter than the penetrating body 520. Because the shoulder 515 has a “thickness” 517 (see FIG. 5C), upon “screwing” the fastening member 505 into a substrate, when contact with the bottom 518 of the shoulder 515 is made, the fastening member 505 is stopped from penetrating any further. The bottom 518 of the shoulder 515 functions similarly to the bottom surface of the “head” of a typical screw, stopping further penetration. The thickness 517 of the shoulder 515 generates the ensuing substrate-to-washer gap for fitment of a clip. The washer 530 acts in a similar fashion to the clip bounding head of the previous embodiments.

The shoulder 515 is shown in these examples as being an abrupt change in diameter from the penetrating body 520, however, it is expressly understood that a side profile of the shoulder 515 may be rounded, tapered, or even hollowed (where the inner diameter of the shoulder is recessed). Accordingly, various modifications and changes may be made without departing from this disclosure. For example, as non-limiting examples, instead of being “disc-shaped,” the shoulder 515 may be star-shaped, oval, square, have grooves, bubbled out from the washer 530, and so forth.

Threads 525 which encircle the penetrating body 520 may or may not extend all the way down to the tip 550 of the penetrating body 520. In this FIG., the threads 525 stop just short of the tip 550, and the remaining portion is shaped to form a drill end 545. The drill end 545 enables the fastening member 505 to be used without requiring a pilot hole or other screw-starting technique, which is particularly useful if trying to “start” the fastening member 505 on hard plastic or metal sheet. Of course, it is fully understood that the drill end 545 is optional and if not used, the threads 525 can extend further nearer the tip 550, if desired. How far the threads 525 extend (either down the penetrating body 520 or up the penetrating body 520) is a design choice.

FIG. 5B is an illustration from a perspective head-side view and better shows the wider diameter of the washer 530 versus the head 510. It is understood here that the washer 530's diameter needs to be larger than the shoulder 515's diameter so as to prevent a clip from falling off, but it is not necessary for the washer 530's diameter to be larger than the head 510's diameter. That is, in in some embodiments, if the head 510 can be sufficiently “wide,” then it negates the need for the washer 530 and the bottom of the head 510 can act as in the embodiment of FIG. 1, to retain the clip.

For practical reasons, however, it is easier and less costly to manufacture a wide inexpensive washer 530 than a washer-less, wide head. Another benefit of using a washer 530 is if the installer is using a socket drive, the socket will rest on the top face 535 (see FIG. 5B) of the washer 530 and the installer can push down on the socket, pushing the washer 530 and the associated fastening member 505 into a substrate to start the penetration. If, however, using a screwdriver, such as a Phillips head as shown in this FIG., then the screwdriver can provide the downward force on the head 510 to drive the fastening member 505 into the substrate to start the penetration.

FIG. 5C shows a side view of an exemplary fastening member 505. Here, the threaded portion of the penetrating body 520 is shown as uniform in diameter, while the drill end 545 is shown as tapering to the tip 550. The uniformness is primarily because metal or even plastic (in some cases) do not rebound well when punctured. Thus, if the threaded portion of the penetrating body is conical or tapered, the fastening member can loosen very easily from the smaller diameter side and fall out of the substate. However, depending on the material of the substrate, the fastening member's composition and associated tradeoffs, the diameter of the penetrating body 520, including along its threaded portion, can vary along its length.

FIG. 5D shows a top view of the exemplary fastening member 505, and is understood to be self-explanatory.

It goes without saying that all of the features described above for the exemplary fastening members are formed as single, integrated piece. In prototype designs, the fastening member 505 was made to be approximately 0.7-0.9 inches long, with a washer 530 of approximately 0.42-0.45 inches in diameter and 0.04 inches in thickness. The shoulder 515 was approximately 0.25 inches in diameter and 0.055 inches in thickness. Of course, these values may be altered as needed and therefore larger, smaller, wider, thicker elements may be arrived at without departing from the spirit and scope of this disclosure.

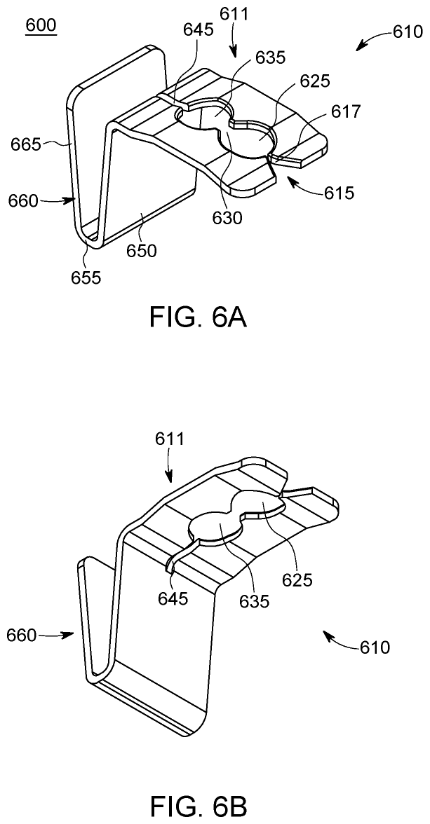

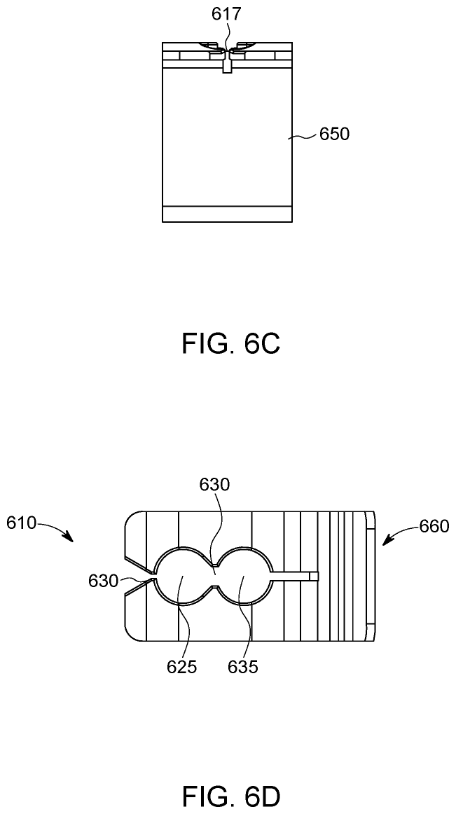

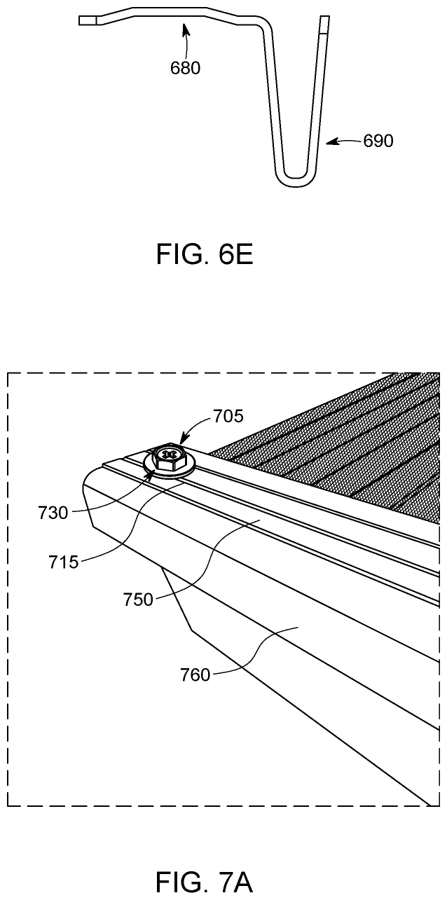

FIGS. 6A-E show various views of another exemplary clip 610, suitable for use with the above exemplary fasteners. FIG. 6A shows a front perspective view, FIG. 6B is shows a bottom perspective view, FIG. 6C shows a front view, FIG. 6D shows a top view, and FIG. 6E shows a side profile view of the exemplary clip 610.

The exemplary clip 610 can be made of plastic, rubber, nylon and other durable material. In a prototype, PP was chosen for the material due to its strength.

FIG. 6A shows a front perspective view 600 where the clip's 610 attachment end 611 is shaped as a semi-planar rectangle, having a front opening 615 that leads to two joined circular holes 625, 635 followed by a cut 645. The front opening 615 provides a means for the clip 610 to be “pushed” onto a fastening member (not shown). The front opening 615 is optionally tapered (e.g., widened) to provide easier guidance of the clip 610 onto the fastening member. The width of the “slit” 617 from the opening 615 to the front hole 625 may be very slight to require moderate force to insert the clip 610 or wide to allow easier insertion. This is a design choice. The two connected holes 625, 635 provide two possible locations for the clip 610 to grab onto the fastening member. This is helpful if the fastening members are installed at various distances from the edge of the gutter. The diameter of the holes 625, 635 are sized to fit about the diameter of the neck 122 (FIG. 1) or shoulder 515 (FIG. 5A).

While two holes are shown, it is possible to have only one hole or more than two holes. Additionally, the holes 625, 635 do not necessarily have to be in line with each other. In some instances, the diameters of the holes may be different. For example, one diameter can be sized for a particular fastening member's neck/shoulder size while the other diameter can be sized for a different fastening member's neck/shoulder size. For practical purposes the holes 625, 635 are circular in form, however, it is possible for the holes to be oval, triangular, and so forth, if so desired. For example, some of the shapes shown in FIGS. 4A-C may be implemented as substitutes for the holes 625, 635.

Because a rectangular form is the easiest to make, attachment end 611 is shown as having the general shape of semi-planar rectangle, however, other shapes such as oval, circular, square, triangular, etc. may be utilized.

Cut 645 in the rear of the attachment end 611 provides stress relief to the clip 610 as pressure is exerted during installation or removal of the clip 610. The hole-to-hole opening width 630 can be slightly smaller than the neck or shoulder of the fastening member, to provide some resistance, if desired, to “lock” the clip 610 into the hole the installer has selected.

Evident in FIGS. 6A-B and especially in FIG. 6E's side view, is the wavy stepped-design 680 to the profile of the attachment end 611. This design is not necessary but provides spring tension to better secure the clip 610 to the fastening member. The stepped-design 680 shown is only one of many possible ways to provide spring tension as a curved, ridged, triangular, wavy, etc. profile can similarly provide different degrees of tension. Thus, these and other forms of profiles may be used without departing from the spirit and scope of this disclosure.

“Hook” end 660 of the clip 610 is integrally connected to the attachment end 611 and provides an open sided well 655 for placement of a wire, holiday light or other item to be secured/held by the clip 610. Back wall 650 is slightly angled to offset the well 655 away from a gutter's face but it may drop perpendicularly or even forward (towards the attachment end 611) if so desired. Front wall 665 can be of any height but generally should be tall enough to prevent dislodging of the item being held in the well 655 due to wind, jostling and other possible disturbances the lodged item is likely to experience.

The slope of the respective walls can be such that they are not parallel to each other, but almost V-shaped 690 as seen in FIG. 6E. The V-like channel 690 is such that it is tighter towards the well's 655 bottom, so a thicker wire strand would sit closer to the top of the clip 610 and a thinner wire strand would rest closer to the bottom—allowing a secure fit for either type.

Back wall 650 and front wall 655 can be solid (as shown) or perforated, slotted for drainage, etc. Further, while they are shown in FIGS. 6A-C as having similar widths, there is no requirement they do so. They can narrow or widen at either ends, or a plurality of side-by-side walls (e.g., fingers) can be used. However, by imposing a non-trivial width to the front wall 655, the front wall 655 can prevent twisting of the clip 610. That is, the clip 610 will not rotate sideways any appreciate amount, as the front wall 655 will eventually strike against the gutter's face. The nature of the hook end 660 structure is to provide a means for retaining an item placed in/on the hook end 660. Therefore, any structure or shape that provides this ability can be used.

In a prototype embodiment, a version of the clip 610 was manufactured from PP of approximately 0.04” thickness, and the approximate dimensions were 0.6” in width, 1.158” in overall length, and 0.83” in height. The well with its walls constituted approximately ⅓ of the length of the clip 610. These dimensions are representative of a prototype and are not absolute. Changes to them for a given design or objective can be made by one of ordinary skill in the art. Thus, various changes or modifications are within the spirit and scope of this disclosure.

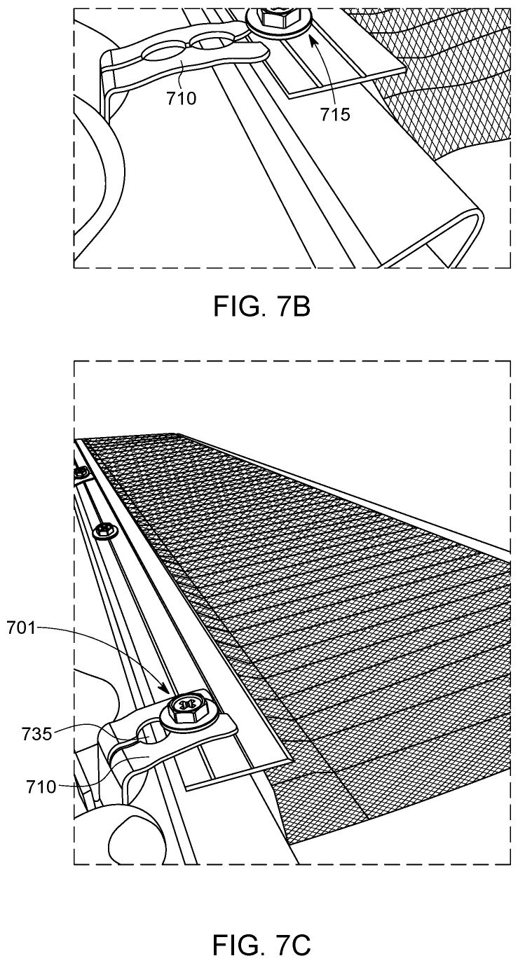

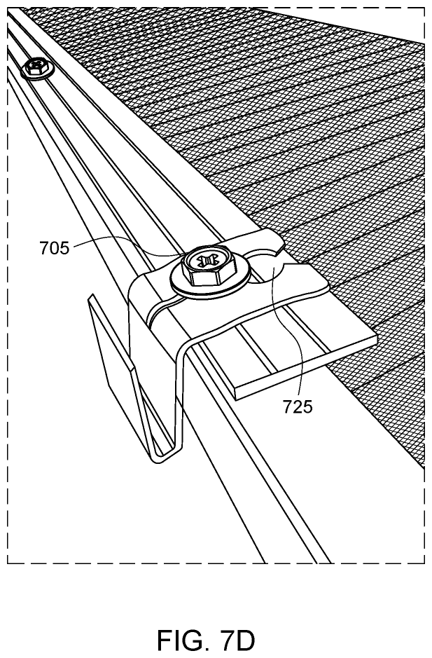

FIG. 7A is a view of the exemplary fastening member 705 attached to the edge of a gutter 760 through a gutter guard 750. Evident is the separation space 715 between the bottom of the integral washer 730 and the top of the gutter guard 750. This separation space 715 provides the gap needed for insertion of an exemplary clip between the gutter guard 750 and the washer 730.

FIG. 7B is a closeup view showing an exemplary clip 710 ready to be inserted into the separation space 715.

FIG. 7C is a closeup view showing an exemplary clip 710 inserted into the separation space, where the first hole (obscured from view) is aligned with the fastening member 701. Secondary hole 735 is seen as not used in this example.

FIG. 7D is a closeup view showing an exemplary clip 710 inserted into the separation space, where the second hole (obscured from view) is aligned with the fastening member 705. First hole 725 is seen as not used in this example.

The above FIGS. illustrate the ease of securing the exemplary clip to an exemplary fastener. An installer can, if so desired, attempt to screw the exemplary fastener even further down after inserting the exemplary clip to add additional pressure to the clip's surface. However, as stated above, if the clip is bowed or not 100% planar, it will offer the desired tension to where additional tightening of the fastener is not necessary.

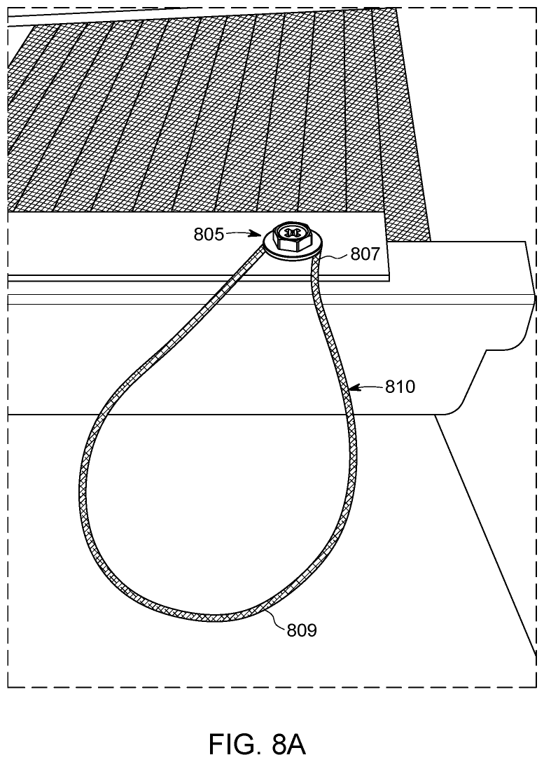

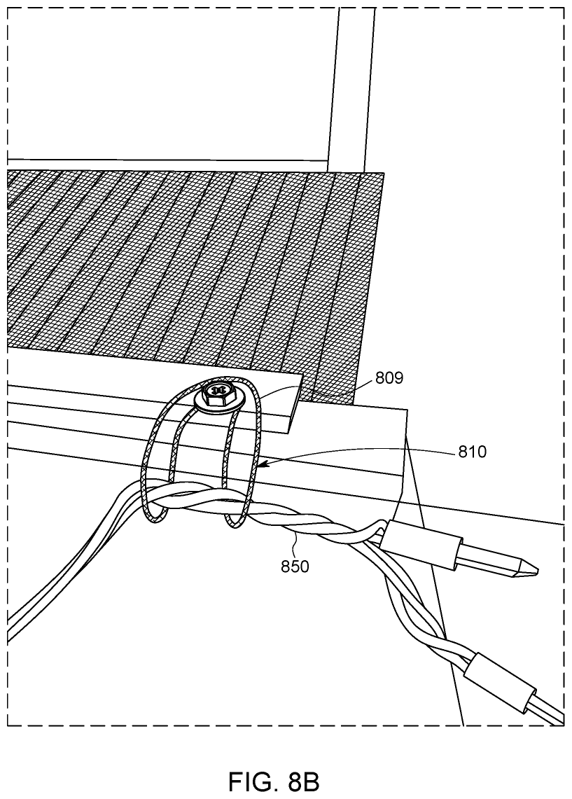

FIGS. 8A-B illustrate another embodiment type for a “clipping” mechanism that can provide a means for securing a light or other device to an exemplary fastening member 805. For example, ends of a non-flexible string, or flexible plastic, rubber or elastic loop 810 can fit over the head of the exemplary fastening member 805 while holding the desired light or other device (not shown). This can be accomplished by placing a first end 807 of the loop 810 “into” exemplary fastening member 805's under-head-gap (obscured from view). Then, placing the light, wire, etc. 850 across a face of the open loop 810 and wrapping a second end 809 of the loop 810 over the light 850 to attach to the fastening member 805. The loop 810 can be circular, oblong, rectangular, whatever shape that allows different ends to “hook” under the fastening member's head. Of course, one may use several loops rather than one.

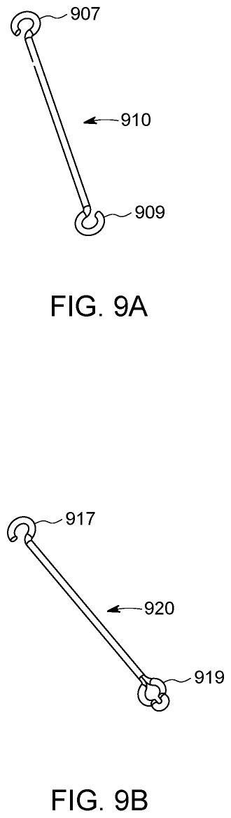

FIGS. 9A-B are examples of variations of the embodiment type shown in FIG. 8A. FIG. 9A shows a single strand “clipping” embodiment 910 where the ends 907 and 909 are individually attached to a fastening member. Like in FIG. 8B, a light or wire can be held in place by looping the strand 910 and affixing the ends 907, 909 of the strand 910 over to “hook” to a fastening member.

FIG. 9B illustrate a variation 920 of the strand embodiment of FIG. 9A wherein one or more of ends 917, 919 are similar to one or more of the forms shown in FIGS. 9A, 4A-C, and FIG. 6A. Combinations of end shapes shown above may be used as desired.

The exemplary embodiments illustrate designs that do not require machines or tools to attach an exemplary“clips” to the exemplary fastener. Installation of the exemplary clip and removal of the exemplary clip can be done by hand. Since the exemplary clip is for outdoor use, it can be made of material that is waterproof and flexible to a certain extent. If made from plastic, nylon, or PP material, it can be easily manufactured, being stamped and molded to the desired shape, for example. If the well (“hook” embodiment) in the clip is sufficiently large, multiple wires can be placed in the well. The installer can hang things other than wires or lights. Since the exemplary fastener is mounted to the gutter guard (and/or gutter lip) there is no damage to the house or roof. The exemplary fasteners can, if so desired, also serve double-duty to fasten the gutter guard to the gutter, thus only one type of fastener is needed to serve both purposes. As evident in the above FIGS, the head of the exposed fasteners are barely viewable, practically no different (appearance wise) than the typical fasteners used to secure a gutter guard to a gutter, and do not alter the aesthetics of the roof or gutter, nor damage them. Because of this, the fasteners can remain all year long while only the clips need to be removed when the lights or wires are no longer desired by the user. And the clips can be simply reinstalled when desired.

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, implementations, and realizations, which can, of course, vary. It is also to be understood that the terminology used herein is for the purpose of describing particular embodiments only and is not intended to be limiting.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A clip-attachable screw configured for screwing into a gutter or gutter guard, comprising:
a head;
a shoulder immediately below and integrally formed to a bottom of the head; and
a threaded screwing body immediately below and integrally formed to a bottom of the shoulder;
wherein a diameter of the threaded screwing body is smaller than a largest diameter of the bottom of the shoulder, and a largest diameter of a top of the shoulder is smaller than a largest diameter of the bottom of the head,
wherein the screw is configured to provide a gap that is a height of the shoulder when the screw is screwed into a substrate, for attachment by a clip.

2. The screw of claim 1, wherein an entirety of the threaded screwing body threaded.

3. The screw of claim 1, wherein a tip of the threaded screwing bottom is formed as a drill end.

4. The screw of claim 1, wherein the bottom of the head is defined by a washer integrally formed to the head.

5. The screw of claim 4, wherein the washer is larger in diameter than a diameter of the head.

6. The screw of claim 1, wherein the bottom of the shoulder is defined by a washer integrally formed to the bottom of the shoulder.

7. The screw of claim 6, wherein a diameter of the washer is approximate to a diameter of the head.

8. The screw of claim 1, wherein sides of the head are octagonally arranged for fitment of a wrench.

9. The screw of claim 1, wherein a top of the head is channeled for fitment of a screwdriver.

10. The screw of claim 1, wherein the screw is between 0.7-0.9 inches in length.

11. The screw of claim 1, wherein a height of the shoulder is between 0.05-0.1 inches.

12. The screw of claim 1, wherein the screw is formed from metal.

13. A clip configured to attach to a gutter guard screw, and configured to provide support for a wire, comprising:
a body having a top member and a side member joined to the top member, wherein the body has a generally L-shaped cross-section, wherein the top member has a distal portion with opposing legs, a separation between the opposing legs forming an attachment structure; and
an attachment mechanism disposed on the side member,
wherein when the clip is in use, the attachment structure is configured to receive the gutter guard screw and the attachment mechanism the wire.

14. The clip of claim 13, wherein the side member is joined to the top member between 45-135 degrees.

15. The clip of claim 13, wherein the attachment structure further comprises a first and second hole, each hole in line with each other and having a passage way therebetween.

16. The clip of claim 15, further comprising, a cut at an end of the second hole to provide stress relief to the clip.

17. The clip of claim 13, wherein the top member is shaped to be slightly non-planar.

18. The clip of claim 13, wherein the attachment structure is an open ended slit.

19. The clip of claim 18, wherein the slit has holes and the holes operate as the attachment mechanism.

20. The clip of claim 13, wherein the side member is multi-walled to form a well for fitment of the wire.

21. The clip of claim 13, wherein the clip is formed from polypropylene plastic.

22. The clip of claim 13, wherein the top member is approximately 0.5-0.9 inches in length and the side member is approximately 0.5-0.3 inches in length.

23. The clip of claim 13, wherein the attachment structure is at least one of shaped as a loop with an upper opening, a main loop with a smaller diameter arc at a top of the main loop, and an opening surrounded with flexing tabs.

24. An integral, one piece loop configured to attach to a prospective clip-attachable, gutter or gutter guard screw, and configured to provide support for a prospective wire or object attached to the loop, comprising:
a single strand having a first and second hooking ends.

25. The loop of claim 24, wherein the hooking ends are at least one of curved with an upper opening, a main loop with a smaller diameter arc at a top of the main loop, and an opening surrounded with flexing tabs.

26. A method of attaching a light or object to a roof edge, comprising:
screwing a clip-attachable, gutter or gutter guard screw into a gutter or gutter guard resting on the gutter, the screw comprising:
a head;
a shoulder immediately below and integrally formed to a bottom of the head; and
a threaded screwing body immediately below and integrally formed to a bottom of the shoulder;
attaching a clip to the screw's shoulder; and
placing the light or object to the clip to be secured by the clip.

27. The method of claim 26, wherein the clip is a loop and ends of the loop are attached to the screw's shoulder with the light or object placed within the loop.
